(19) United States
(12) Patent Application Publication
(10) Pub. No.: US 2015/0355463 A1
(43) Pub. Date: Dec. 10, 2015

(54) IMAGE DISPLAY APPARATUS, IMAGE DISPLAY METHOD, AND IMAGE DISPLAY SYSTEM

(71) Applicant: SONY CORPORATION, Minato-ku, Tokyo (JP)

(72) Inventors: Yoichiro Sako, Tokyo (JP); Masashi Takeda, Tokyo (JP)

(73) Assignee: SONY CORPORATION, Tokyo (JP)

(21) Appl. No.: 14/761,148

(22) PCT Filed: Oct. 31, 2013
(86) PCT No.: PCT/JP2013/079508

§ 371 Date: Jul. 15, 2015

(30) Foreign Application Priority Data
Jan. 24, 2013 (JP) 2013-011147

(51) Int. Cl. G02B 27/01; G06T 19/00; H04N 5/232; G06F 3/147

(52) U.S. Cl. CPC G02B 27/017; G06F 3/147; G06T 19/006; H04N 5/23293; G02B 2027/0138; G02B 2027/0178

(57) ABSTRACT

An image obtained when a rare or valuable thing is found is shared between users each wearing an image display apparatus on the head or face.

When a man finds a rare or valuable thing, the man feels like telling it to his/her surroundings. For example, when the man finds a planet such as Venus or shooting stars in the night sky, fish or a fresh water crab in a pond or a river, a bird, a cicada, a unicorn beetle, or the like on a tall tree in the woods, the man feels like saying “Look there!” An image display apparatus 100 releases a captured image in a line-of-sight direction of the user to share a user's precious experience with other users.

### TECHNICAL FIELD

The technology disclosed in this specification relates to an image display apparatus that is used by being mounted onto the head or face of a user, an image display method, and an image display system, and particularly to an image display apparatus and an image display method with which users share information, and to an image display system.

### BACKGROUND ART

There is known an image display apparatus that is mounted onto the head or face of a user to view images, that is, a head-mounted display. The head-mounted display is provided with image display units for right and left eyes, for example, and forms an enlarged virtual image of a displayed image by a virtual-image optical system, thus allowing a user to observe a realistic image. Additionally, if a head-mounted display is configured so as to completely interrupt the outside world when a user wears the head-mounted display on the user's head, a sense of immersion in viewing is increased. Further, the head-mounted display is capable of displaying different videos for the right and left eyes. If images with parallax are displayed for the right and left eyes, it is possible to present a three-dimensional (3D) image.

Using a head-mounted display, it is possible to view not only images reproduced from media such as Blu-ray discs but also other various images. For example, the following application is conceivable, in which live images transmitted from an external device are viewed with a head-mounted display. There is also proposed an image display system in which images actually captured with an imaging device mounted in a mobile object such as a radio control device are displayed in a display apparatus worn by the user (for example, see Patent Document 1).

The head-mounted display is very popular. If the head-mounted display is increasingly mass-produced, the head-mounted display may be widely used like mobile phones, smartphones, and portable game machines, and every person may carry his/her own head-mounted display.

At present, information is actively exchanged via smartphones. Examples of handled information include data edited on smartphone (including mails), captured images, and content downloaded to smartphones. In contrast to this, the head-mounted display has a feature of easily taking in an image in a hands-free manner, the image being in a line-of-sight direction of a user wearing the head-mounted display. There is also conceivable an image display system in which field-of-view images are exchanged between users wearing eyeglass-type display cameras.

For example, there is proposed a display apparatus that receives and displays an image, which is obtained by capturing a scene viewed through an imaging display apparatus worn by another person (for example, see Patent Document 2). In a display system including an imaging display apparatus and a display apparatus, basically, the imaging display apparatus (that serves as an image providing source) is configured so as to provide an image according to a request for the image from the display apparatus (that receives the image). A user wearing the display apparatus can view the scene viewed by another person. However, when a user of the imaging display apparatus on the images providing side finds a rare or valuable thing, for example, it seems that the user sometimes wants to immediately transmit images without waiting for a request for images. For example, there is a case where scenes move instantaneously, such as a case where the user finds an animal running away. Further, the user of the display apparatus does not know which imaging display apparatus provides a scene of a field of view worth viewing, and thus has to tentatively specify any one of the imaging display apparatuses to transmit an image request thereto.

Additionally, there is proposed an imaging display system in which one imaging display apparatus captures an image in a field-of-view direction of a user and transmits the image to another imaging display apparatus for display or recording, or one imaging display apparatus records an image in a field-of-view direction of a user and causes another imaging display apparatus to reproduce the image (see, for example, Patent Document 3). In this imaging display system, the user of one imaging display apparatus operates using a remote controller to instruct both of the imaging display apparatuses to perform a vision exchange operation. In other words, when the user of one imaging display apparatus wants to transmit his/her own visual image to another imaging display apparatus or wants to view a visual image of the other imaging display apparatus, the user can give an instruction to perform a vision exchange operation. However, when the user of the other imaging display apparatus without a remote controller finds a rare or valuable thing, for example, the user has no way of giving an instruction to perform a vision exchange operation if the user wants to transmit his/her own visual image to the one imaging display apparatus.

### SUMMARY OF INVENTION

### Problem to be Solved by the Invention

It is an object of the technology disclosed in this specification to provide an excellent image display apparatus, image display method, and image display system that are used by being mounted onto the head or face of a user and are capable of suitably sharing information between users.

### Means for Solving the Problem

The present application has been made in view of the problems described above. According to the technology of claim 1, there is provided an image display apparatus of a head- or face-mounted type, the image display apparatus including: an image display unit that displays an image; an image input unit that inputs an image; a reception-terminal setting unit that sets a reception terminal, the reception terminal being a transmission destination of the image input to the image input unit; and an image transmission unit that transmits the image to the reception terminal, the image being input to the image input unit.

According to the technology of claim 2 of the present application, the image display apparatus according to claim 1 further includes a state detection unit that detects a state of a user who uses the image display apparatus, in which in response to a detection of a predetermined state of the user by the state detection unit, the image transmission unit starts or stops transmitting the image to the reception terminal, the image being input to the image input unit.

According to the technology of claim 3 of the present application, in the image display apparatus according to claim 1, the reception-terminal setting unit transmits an image release message and sets a reception terminal that returns an acknowledgment message.

According to the technology of claim 4 of the present application, in the image display apparatus according to claim 1, when the reception-terminal setting unit cannot set any one reception terminal, the image transmission unit does not transmit the image input to the image input unit.

According to the technology of claim 5 of the present application, the image display apparatus according to claim 1 further include an additional information creation unit that creates additional information, the additional information being transmitted together with the image input to the image input unit, in which the image transmission unit transmits the additional information to the reception terminal, together with the image input to the image input unit.

According to the technology of claim 6 of the present application, in the image display apparatus according to claim 5, the reception-terminal setting unit classifies the reception terminals into two or more categories, and the image transmission unit transmits the additional information to only the reception terminal in a predetermined category.

According to the technology of claim 7 of the present application, in the image display apparatus according to claim 5, the image input unit inputs an image in a line-of-sight direction of a user who uses the image display apparatus, and the additional information creation unit creates additional information on a line of sight of the user or additional information indicating an object in a line-of-sight direction.

According to the technology of claim 8 of the present application, the image display apparatus according to claim 1 further include an imaging unit, in which the image input unit inputs an image captured by the imaging unit.

According to the technology of claim 9 of the present application, the image display apparatus according to claim 1 further include: an imaging unit; and a recording unit that records a captured image of the imaging unit, in which the image input unit inputs the captured image from the recording unit.

Further, according to the technology of claim 10 of the present application, there is provided an image display apparatus of a head- or face-mounted type, the image display apparatus including: an image reception processing unit that performs reception processing on an image transmitted from a transmission terminal; and an image display unit that displays the image subjected to the reception processing.

According to the technology of claim 11 of the present application, the image display apparatus according to claim 10 further include a transmission-terminal setting unit that sets the transmission terminal, in which the image reception processing unit receives only an image from the transmission terminal, the transmission terminal being set by the transmission-terminal setting unit.

According to the technology of claim 12 of the present application, in the image display apparatus according to claim 11, the transmission-terminal setting unit returns an acknowledgment message in response to an image release message from the transmission terminal.

According to the technology of claim 13 of the present application, in the image display apparatus according to claim 10, the image reception processing unit selectively receives additional information that is transmitted together with the image.

According to the technology of claim 14 of the present application, in the image display apparatus according to claim 10, the image display unit includes display screens for right and left eyes of a user who uses the image display unit, and displays the image on any one of right and left display screens, the image being subjected to the reception processing.

According to the technology of claim 15 of the present application, in the image display apparatus according to claim 10, the image display unit displays the image on the display screen as a sub-screen or a split screen, the image being subjected to the reception processing.

According to the technology of claim 16 of the present application, in the image display apparatus according to claim 10, the image reception processing unit performs display processing of additional information transmitted together with the image.

According to the technology of claim 17 of the present application, the transmission terminal transmits an image in a line-of-sight direction of a user of the transmission terminal, together with additional information containing information on a line of sight of the user, and in the image display apparatus according to claim 10, the image reception processing unit performs special processing on the image received from the transmission terminal, based on the information on the line of sight of the user, the information being received as the additional information.

Further, according to the technology of claim 18 of the present application, there is provided an image display method, including: inputting an image; setting a reception terminal, the reception terminal being a transmission destination of the image input in the step of inputting an image; and transmitting the image to the reception terminal, the image being input in the step of inputting an image.

Furthermore, according to the technology of claim 19 of the present application, there is provided an image display method, including: performing reception processing on an image transmitted from a transmission terminal; and outputting the image for display, the image being subjected to the reception processing.

Moreover, according to the technology of claim 20 of the present application, there is provided an image display system, including: a transmission-side image display apparatus of a head- or face-mounted type, the transmission-side image display apparatus transmitting an input image; and a reception-side image display apparatus of a head- or face-mounted type, the reception-side image display apparatus displaying the image transmitted from the transmission-side image display apparatus.

It should be noted that the “system” used herein refers to the aggregate of a plurality of apparatuses (or functional modules to achieve specific functions) logically collected, and whether the apparatuses or functional modules exist in a single casing or not is not taken into consideration.

### Effect of the Invention

According to the technology disclosed in this specification, it is possible to provide an excellent image display apparatus, image display method, and image display system that are used by being mounted onto the head or face of a user and are capable of suitably sharing information between users.

According to the technology disclosed herein, a user wearing the image display apparatus on his/her head or face can release an image, which is obtained by capturing his/her own line-of-sight direction, to another user, when the user finds a rare or valuable thing, for example.

Still another objects, features, and advantages of the technology disclosed herein will be clearly described in more detail based on embodiments to be described later and attached drawings.

### BRIEF DESCRIPTION OF DRAWINGS

FIG. 1 is a diagram showing a state where a user wearing a transmissive head-mounted image display apparatus 100 is viewed from the front.

FIG. 2 is a diagram showing a state where the user wearing the image display apparatus 100 shown in FIG. 1 is viewed from above.

FIG. 3 is a diagram showing a state where a user wearing a light-shielding head-mounted image display apparatus 300 is viewed from the front.

FIG. 4 is a diagram showing a state where the user wearing the image display apparatus 300 shown in FIG. 3 is viewed from above.

FIG. 5 is a diagram showing an internal configuration example of the image display apparatus 100.

FIG. 6 is a diagram showing a functional configuration for the image display apparatus 100 to operate for a field-of-view provider.

FIG. 7 is a flowchart of a processing procedure for the image display apparatus 100 to operate for the field-of-view provider.

FIG. 8 is a diagram showing a functional configuration for the image display apparatus 100 to operate for a field-of-view receiver.

FIG. 9 is a flowchart of a processing procedure for the image display apparatus 100 to operate for the field-of-view receiver.

FIG. 10 is a diagram showing a state where an image display apparatus 100 mounted onto the head or face of one user is transmitting information to image display apparatuses respectively worn by a plurality of other users.

FIG. 11 is a diagram showing an exemplary image (a scene in which fish has just jumped up from the water surface of a pond) provided by the field-of-view provider.

FIG. 12 is a diagram showing an exemplary image (a scene in which a rare bird has just flown out of trees) provided by the field-of-view provider.

FIG. 13 is a diagram showing a state where a marker is provided to a target object (fish that has just jumped up from a pond) in an image provided by the field-of-view provider.

FIG. 14 is a diagram showing a state where a zoomed-in image of a target object (fish that has just jumped up from a pond) in an image provided by the field-of-view provider is created.

FIG. 15 is a diagram showing a state where a marker is provided to a target object (rare bird that has just flown out of trees) in an image provided by the field-of-view provider.

FIG. 16 is a diagram showing a state where a zoomed-in image of a target object (rare bird that has just flown out of trees) in an image provided by the field-of-view provider is created.

FIG. 17 is a diagram showing a state where a field-of-view image of a field-of-view provider viewing a pond is displayed on a small screen of a field-of-view receiver viewing a street corner, the field-of-view image being transmitted from the field-of-view provider.

FIG. 18 is a diagram showing a state where the field-of-view image of the field-of-view receiver, which is on a main screen, and the image provided by the field-of-view provider, which is on a sub-screen, are replaced with each other.

FIG. 19 is a diagram showing a state where a field of view of the field-of-view receiver and the image provided by the field-of-view provider are displayed by splitting the screen.

FIG. 20 is a diagram showing a state where the field of view of the field-of-view receiver is see-through displayed on the left side of a binocular image display apparatus 100 and the image transmitted from the field-of-view provider is displayed on the right side thereof.

### MODE(S) FOR CARRYING OUT THE INVENTION

Hereinafter, embodiments of the technology disclosed in this specification will be described in detail with reference to the drawings.

A. Configuration of Apparatus

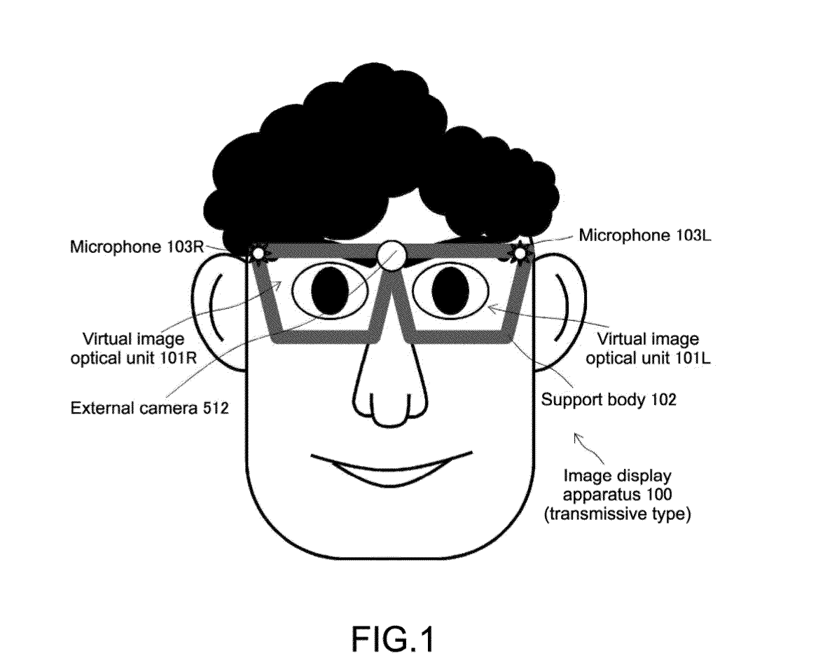

FIG. 1 shows the outer appearance configuration of an image display apparatus 100 according to an embodiment of the technology disclosed herein. The image display apparatus 100 is used by being mounted onto the head or face of a user, and displays images for right and left eyes. The image display apparatus 100 shown in the figure is a transmissive type, that is, a see-through type, with which the user can view (that is, see through) a landscape in the real world through an image during display of images. As a result, it is possible to superimpose a virtual displayed image on the landscape in the real world (see, for example, Patent Document 4). Since the displayed image is not seen from the outside (in other words, by anyone else), it is easy to protect the privacy of the user when information is displayed.

The image display apparatus 100 shown in the figure has a structure similar to eye correction glasses. At positions of the main body of the image display apparatus 100, which are opposed to the right and left eyes of the user, virtual image optical units 101R and 101L formed of transparent light guide units or the like are disposed, respectively. Images (not shown) observed by the user are displayed on the inside of the virtual image optical units 101R and 101L. Each of the virtual image optical units 101R and 101L is supported by, for example, an eyeglass-frame-shaped support body 102.

At substantially the center of the eyeglass-frame-shaped support body 102, an external camera 512 for inputting images of surroundings (a field of view of the user) is provided. The external camera 512 can capture an image of a landscape in a user's line-of-sight direction, for example. The external camera 512 is desirably configured so as to be capable of acquiring three-dimensional information on the images of surroundings. For example, if the external camera 512 is formed of a plurality of cameras, the three-dimensional information on the images of surroundings can be acquired using parallax information. Additionally, even one camera can perform imaging while being moved using a SLAM (Simultaneous Localization and Mapping) image recognition, and calculate parallax information using a plurality of frame images temporally anterior and posterior (see, for example, Patent Document 5), to acquire three-dimensional information on the images of surroundings based on the calculated parallax information. Additionally, in the vicinity of both right and left ends of the support body 102, microphones 103R and 103L are provided, respectively. With the microphones 103R and 103L being provided substantially symmetrically, only sounds (voice of the user) localized at the center are recognized, and can thus be separated from noise of surroundings and voices of other people. For example, this allows prevention of malfunctions when an operation by voice input is made.

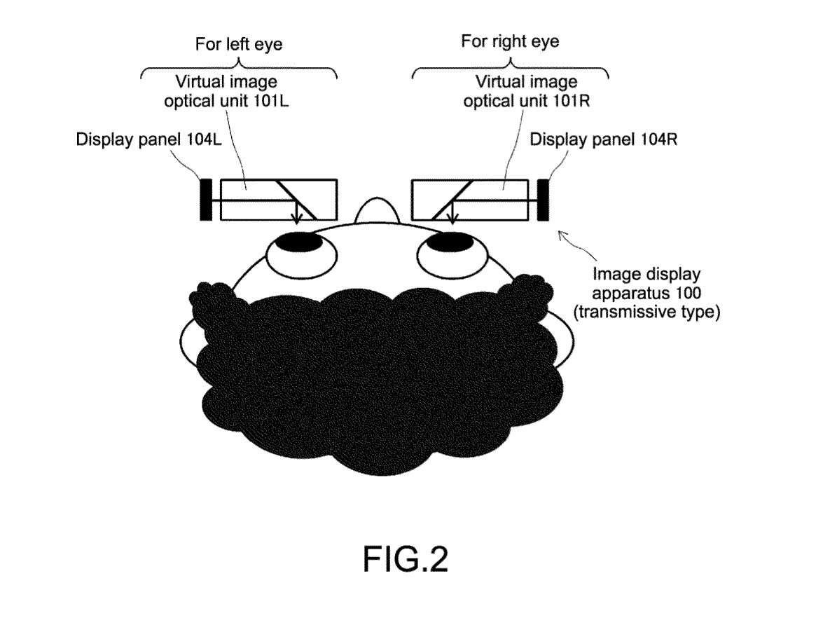

FIG. 2 shows a state where the image display apparatus 100 worn by the user is viewed from above. As shown in the figure, at both right and left ends of the image display apparatus 100, display panels 104R and 104L to display and output right-eye and left-eye images, respectively, are disposed. Each of the display panels 104R and 104L is formed of a microdisplay such as a liquid crystal display or an organic EL device. The right and left displayed images output from the display panels 104R and 104L are guided by the virtual image optical units 101R and 101L to the vicinity of the respective right and left eyes, and then enlarged virtual images thereof are formed on the pupils of the user.

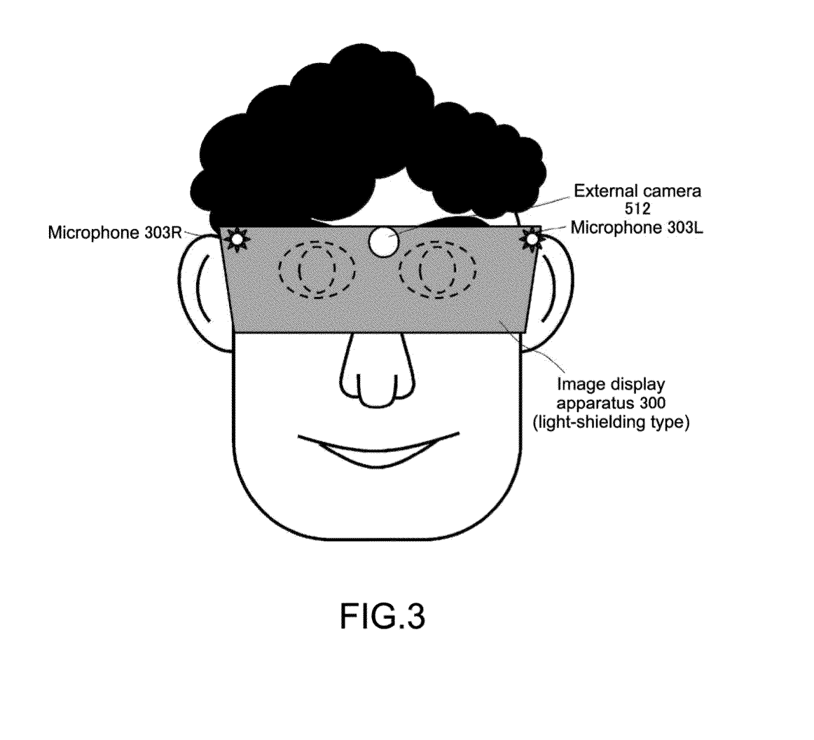

Further, FIG. 3 shows the outer appearance configuration of an image display apparatus 300 according to another embodiment of the technology disclosed herein. The image display apparatus 300, which is used by being mounted onto the head or face of the user, has light-shielding property and can directly cover the eyes of the user when being mounted onto the head, to give a sense of immersion to the user who is viewing images. Moreover, unlike a see-through type, a user wearing the image display apparatus 300 cannot directly view a landscape in the real world. When an external camera 512 to capture an image of a landscape in a user's line-of-sight direction is provided and a captured image is displayed, the user can indirectly view (that is, video see through) the landscape in the real world. As a matter of course, a virtual displayed image can be superimposed on a video see-through image. Since the displayed image is not seen from the outside (in other words, by anyone else), it is easy to protect the privacy of the user when information is displayed.

The image display apparatus 300 shown in the figure has a structure similar to a shape of a hat and is configured to directly cover the right and left eyes of the user wearing the image display apparatus 300. At inside positions of the main body of the image display apparatus 300, which are opposed to the right and left eyes of the user, display panels (not shown in FIG. 3) observed by the user are disposed. Each of the display panels is formed of a microdisplay such as an organic EL device or a liquid crystal display.

At substantially the center of the front of the main body of the image display apparatus 300 having a hat-like shape, an external camera 512 for inputting images of surroundings (a field of view of the user) is provided. Additionally, in the vicinity of both right and left ends of the main body of the image display apparatus 300, microphones 303R and 303L are provided, respectively. With the microphones 303R and 303L being provided substantially symmetrically, only sounds (voice of the user) localized at the center are recognized, and can thus be separated from noise of surroundings and voices of other people. For example, this allows prevention of malfunctions when an operation by voice input is made.

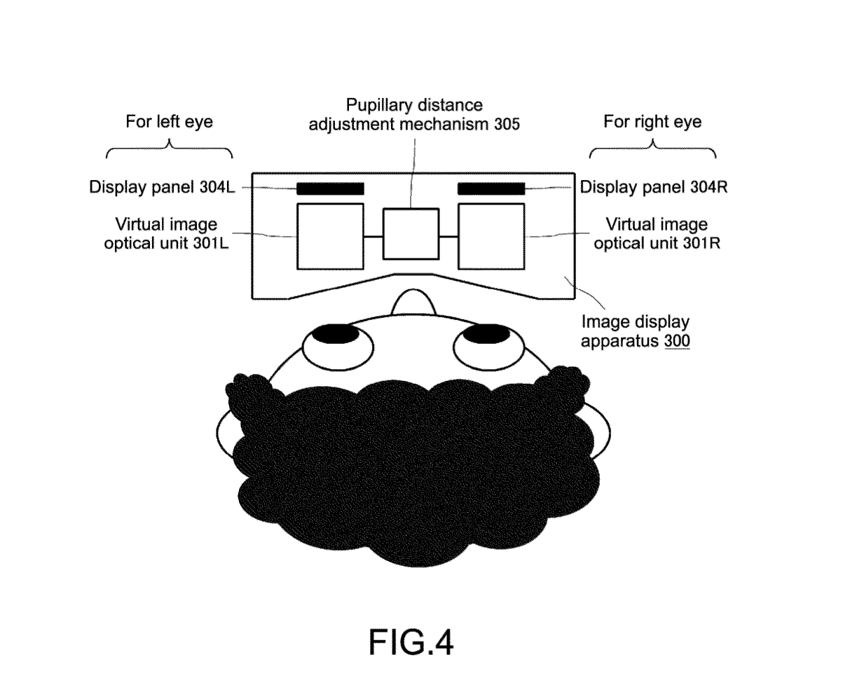

FIG. 4 shows a state where the user wearing the image display apparatus 300 shown in FIG. 3 is viewed from above. The image display apparatus 300 shown in the figure includes display panels 304R and 304L for right eye and left eye, respectively, on the side surface opposed to the face of the user. Each of the display panels 304R and 304L is formed of a microdisplay such as an organic EL device or a liquid crystal display. The displayed images of the display panels 304R and 304L pass through virtual image optical units 301R and 301L, respectively, to be observed by the user as enlarged virtual images. Further, since the height of eyes and a pupillary distance thereof are individually different between users, the right and left display systems and the eyes of the user wearing the image display apparatus 300 are required to be aligned. In the example shown in FIG. 4, a pupillary distance adjustment mechanism 305 is provided between the right-eye display panel and the left-eye display panel.

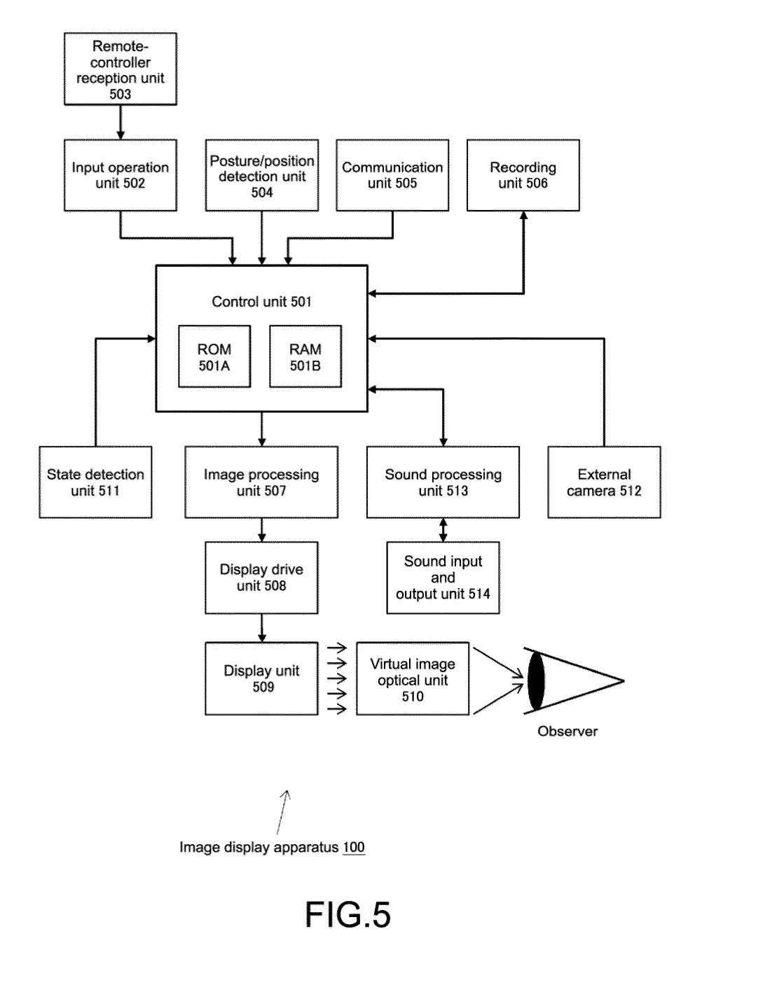

FIG. 5 shows an internal configuration example of the image display apparatus 100. It should be understood that the other image display apparatus 300 also has a similar internal configuration. Hereinafter, the units will be described.

A control unit 501 includes a ROM (Read Only Memory) 501A and a RAM (Random Access Memory) 501B. The ROM 501A stores program codes and various types of data that are executed in the control unit 501. The control unit 501 executes a program loaded to the RAM 501B, to start display control of images and collectively control the whole operation of the image display apparatus 100. Examples of the programs and data stored in the ROM 501A include an image display control program, an image processing program of images captured by the external camera 512 (for example, images obtained by capturing a user's line-of-sight direction), a processing program for communication with external devices such as an image display apparatus of another user and a server on the Internet (not shown), and identification information unique to the apparatus 100.

An input operation unit 502 includes at least one operation element such as a key, a button, and a switch, with which the user performs an input operation. The input operation unit 502 receives a user's instruction made via the operation element and outputs the instruction to the control unit 501. Additionally, the input operation unit 502 similarly receives a user's instruction, which is a remote-controller command received by a remote-controller reception unit 503, and outputs the instruction to the control unit 501.

A posture/position detection unit 504 is a unit that detects a posture or position of the head of the user wearing the image processing apparatus 100. The posture/position detection unit 504 is formed of any one of a gyroscope, an acceleration sensor, a GPS (Global Positioning System) sensor, and a geomagnetic sensor, or a combination of two or more those sensors in consideration of their advantages and disadvantages.

A state detection unit 511 acquires state information on a state of the user wearing the image display apparatus 100 and outputs the state information to the control unit 501. As the state information, for example, the state detection unit 511 acquires an operating state of the user (whether the user wears the image display apparatus 100 or not), a behavioral state of the user (states of movement such as rest, walking, and running, an open or closed state of eyelids, and line-of-sight direction), a mental state (the degree of impression, excitation, or wakefulness, feelings, emotions, etc. on whether the user is immersed or concentrated in observation of displayed image), and a physiological state. Additionally, the state detection unit 511 may include, in order to acquires those pieces of state information from the user, various state sensors (not shown) such as a mounted sensor formed of a mechanical switch and the like, an internal camera to capture an image of the face of the user, a gyroscope, an acceleration sensor, a velocity sensor, a pressure sensor, a bodily temperature sensor, a perspiration sensor, an electromyogram sensor, an electrooculography sensor, and a brain wave sensor.

The external camera 512 is arranged at substantially the center of the front of the main body of the eyeglass-shaped image display apparatus 100, for example (see FIG. 1), and can capture images of surroundings. Additionally, the posture of the external camera 512 in pan, tilt, and roll directions can be controlled in accordance with the user's line-of-sight direction detected by the state detection unit 511, and thus an image in a user's own line of sight, that is, an image in the user's line-of-sight direction can be captured with use of the external camera 512. The user can adjust zooming of the external camera 512 via an operation of the input operation unit 502 or voice input. The image captured by the external camera 512 can be output to a display unit 509 for display, and can also be stored in a recording unit 506.

A communication unit 505 performs processing for communication with an external device such as a server on the Internet (not shown) and also performs modulation/demodulation and coding/decoding processing for communication signals. Additionally, the control unit 501 transmits data from the communication unit 505, the data being transmitted to an external device. The communication unit 505 has an arbitrary configuration. For example, the communication unit 505 can be configured according to communication standards used for operations of transmission/reception with an external device as the other party of communication. The communication standards may be in any one of wired and wireless forms. Examples of the communication standards used here include MHL (Mobile High-definition Link), USB (Universal Serial Bus), HDMI (registered trademark) (High Definition Multimedia Interface), Wi-Fi (registered trademark), Bluetooth (registered trademark) communication, and infrared communication.

Alternatively, the communication unit 505 may be a cellular radio transceiver, which operates according to the standards such as W-CDMA (Wideband Code Division Multiple Access) and LTE (Long Term Evolution).

The recording unit 506 is a large-capacity storage device formed of an SSD (Solid State Drive) or the like. The recording unit 506 stores application programs executed in the control unit 501 and data such as images captured by the external camera 512 (that will be described later) and images acquired from a network via the communication unit 505.

An image processing unit 507 further performs signal processing, such as image quality correction, on image signals output from the control unit 501 and also converts the image signals into those having resolution conforming to the screen of the display unit 509. A display drive unit 508 then selects pixels of the display unit 509 in a sequential manner on a row-by-row basis and scans the pixels in a line-sequential manner, to supply pixel signals based on the image signals subjected to the signal processing.

The display unit 509 includes a display panel formed of a microdisplay such as an organic EL (Electro-Luminescence) element or a liquid crystal display. A virtual image optical unit 510 projects the displayed image of the display unit 509 in an enlarged manner, to cause the user to observe the image as an enlarged virtual image.

A sound processing unit 513 further performs sound quality correction and sound amplification on sound signals output from the control unit 501 and performs signal processing on input sound signals and the like. A sound input and output unit 514 then outputs the sounds subjected to the sound processing to the outside, and inputs sounds from the microphones (described above).

B. Field-of-View Exchange Using Image Display Apparatus

A user wearing the image display apparatus 100 can observe a landscape in a user's own field-of-view direction through a displayed image of the display unit 509. As a matter of course, a user wearing the image display apparatus 300 can also observe a configuration in a user's own field-of-view direction as a video see-through image captured by the external camera 512.

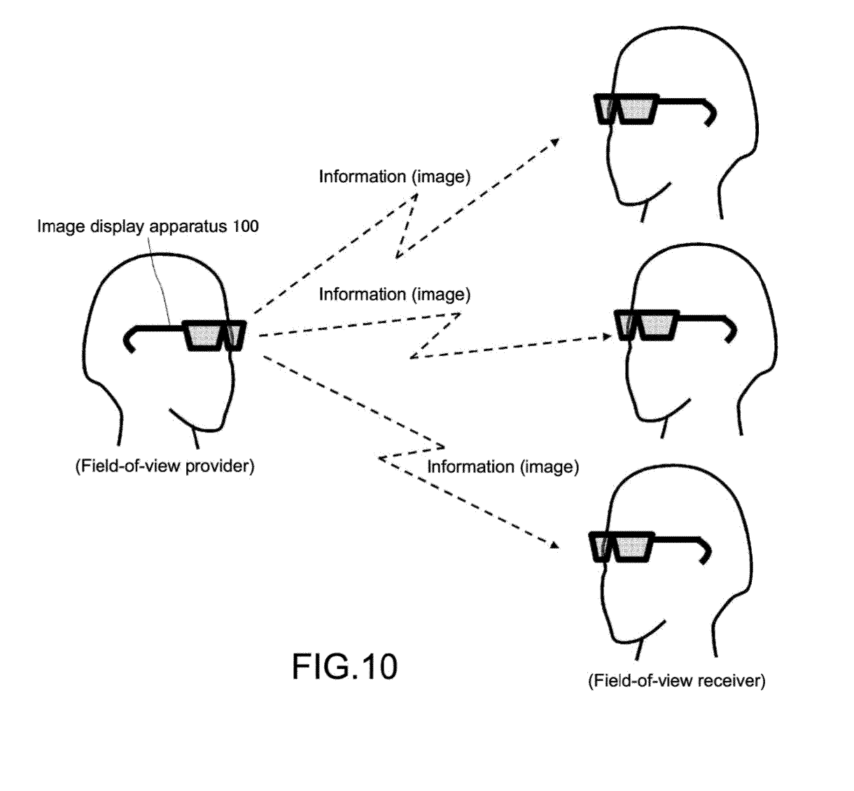

Additionally, the image display apparatus 100 (and the image display apparatus 300) can communicate with an image display apparatus worn by another user via the communication unit 505, to exchange information. FIG. 10 shows a state where the image display apparatus 100 mounted onto the head or face of one user is transmitting information (e.g., images obtained by capturing a line-of-sight direction of the user) to image display apparatuses respectively worn by a plurality of other users. In the following description, information exchange in a multiuser environment of a plurality of users wearing the respective image display apparatuses 100 will be considered.

Irrespective of the types of information, such as images, sounds, texts, and programs, a plurality of image display apparatuses 100 can exchange information. Each of the image display apparatuses 100 is used by being mounted onto the head or face of a user, and thus an image of a landscape in a user's line-of-sight direction can be captured by the external camera 512. If a mounting position of the image display apparatus 100 or the line-of-sight direction of the user, that is, of the external camera 512 is changed, an image to be captured is also changed. Consequently, an image captured by the external camera 512 of the image display apparatus 100 of a certain user is different from an image captured by the external camera 512 of the image display apparatus 100 of another user and is unique information.

Also with a mobile terminal equipped with a camera, an image of a scene in a user's field-of-view direction can be captured. However, the user has to perform an imaging operation with both the hands (for example, holding a mobile terminal with one hand and operating a shutter with the other hand) and cannot capture images any time (cannot capture images with both the hands being full). In contrast to this, according to the image display apparatus 100, an image of a landscape in a user's line-of-sight direction can be captured using the external camera 512 any time in a hands-free manner. For example, according to a change in user's state detected by the state detection unit 511 or a sound from the sound input and output unit 514, the shutter of the external camera 512 can be released. Alternatively, panning may be performed by the external camera 512.

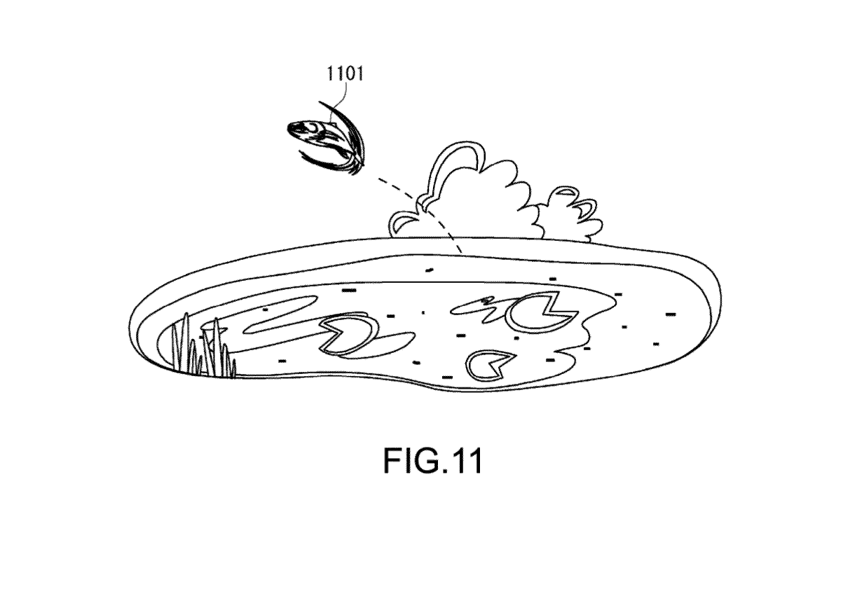

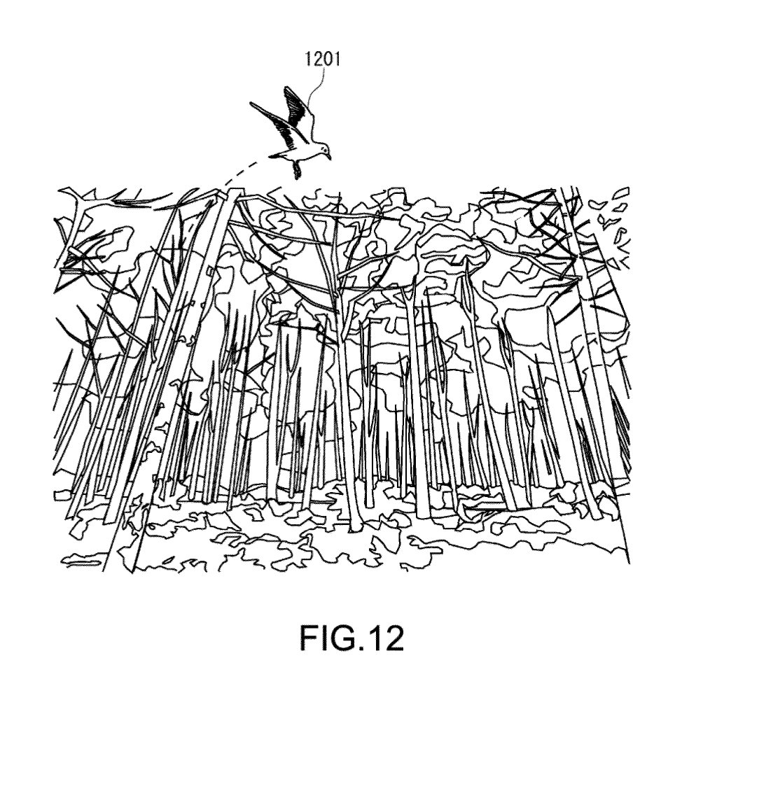

When finding a rare or valuable thing, a man feels like telling it to his/her surroundings. For example, when the man finds a planet such as Venus or shooting stars in the night sky, fish or a fresh water crab in a pond or a river, a bird, a cicada, a unicorn beetle, or the like on a tall tree in the woods, the man feels like saying “Look there!” For example, a scene in which fish 1101 has just jumped up from the water surface of a pond (see FIG. 11), a scene in which a rare bird 1201 has just flown out of trees (see FIG. 12), and the like are rare or valuable scenes. A user who has seen such a scene is impressed or excited and feels like showing the scene to someone if possible (sharing his/her field of view). Furthermore, the fish goes below the water surface again and disappears from the user's sight or the bird flies out of sight, and thus immediacy is required if the user intends to show the scene to someone.

In such a case, the user wearing the image display apparatus 100 can immediately transmit or release an image, which is obtained by capturing a user's own line-of-sight direction by the external camera 512, to an image display apparatus of a surrounding user, without taking a camera from a user's pocket or bag to perform an imaging operation.

Meanwhile, when viewing a received image, the surrounding user feels like saying “Which?” or “Where?” The surrounding user then finds the rare or valuable thing immediately and can sympathize while shouting with pleasure, “Found it. Great!”

In the multiuser environment of the plurality of users wearing the respective image display apparatuses 100, an image display apparatus 100 (an image display apparatus on the image transmitting side) that is worn by a user who plays a role of transmitting or releasing an image in a user's line-of-sight direction to an image display apparatus of a surrounding user is referred to as a “field-of-view provider”, and an image display apparatus 100 (an image display apparatus on the image receiving side) that is worn by a user who plays a role of viewing the image received from the field-of-view provider is referred to as a “field-of-view receiver”. As a matter of course, which role of a field-of-view provider and a field-of-view receiver the image display apparatus 100 plays is not fixed, and an image display apparatus 100 worn by any user may become a field-of-view provider at the time when the user transmits or releases an image in the user's own line-of-sight direction to the surrounding user. Further, at the time when the image in the user's own line-of-sight direction is not necessary to be provided, the image display apparatus 100 can go back to be a field-of-view receiver and receive an image provided by another field-of-view provider, to show the image to the user.

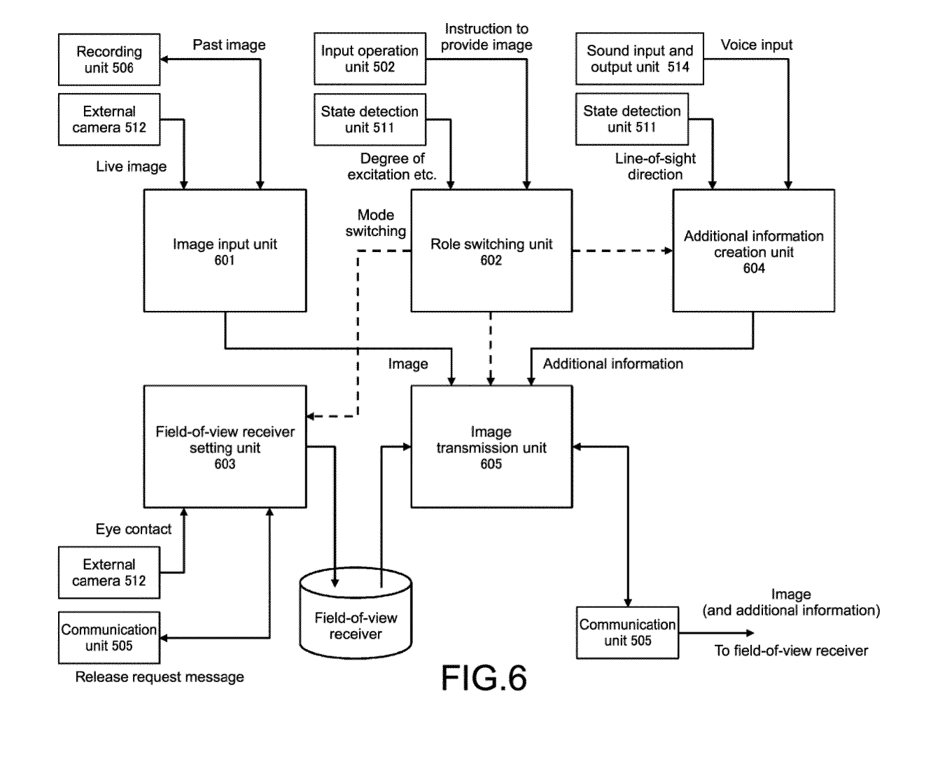

FIG. 6 shows a functional configuration for the image display apparatus 100 to operate for a field-of-view provider.

An image input unit 601 inputs an image to be provided to the field-of-view receiver. The image input unit 601 can input a live image in a user's line-of-sight direction, which is captured by the external camera 512, for example. Additionally, the image input unit 601 can input past captured images stored in the recording unit 506. In other words, the image input unit 601 can input images taken in from the outside via the communication unit 505 (for example, images in line-of-sight direction of other users or images put on the network).

As described above, the external camera 512 controls a posture in accordance with the user's line-of-sight direction, which is detected in the state detection unit 511, to capture an image in the user's line-of-sight direction. Additionally, the user can adjust zooming of the external camera 512 through an operation of the input operation unit 502 or voice input. In this case, the image input unit 601 receives an input of a live image in the user's line-of-sight direction. As a matter of course, the past captured images of the user's line-of-sight direction, which are stored in the storage unit 506, can be input to the image input unit 601.

It should be noted that the external camera 512 may capture a wide-angle image, and the image input unit 601 may input a captured image that is cut out from the wide-angle image into a predetermined angle of view in accordance with the line-of-sight direction of the field-of-view receiver.

A role switching unit 602 switches behavior of the image display apparatus 100 between a field-of-view provider and a field-of-view receiver. In the initial state, the role switching unit 602 sets the image display apparatus 100 to be in a field-of-view receiver mode and waits for images provided from another image display apparatus that operates as a field-of-view provider. When the user finds a rare or valuable thing, the role switching unit 602 switches the image display apparatus 100 to be a field-of-view provider. For example, in the case where the field-of-view provider gives an instruction to manually provide an image via a remote controller or the input operation unit 502 or in the case where the state detection unit 511 detects a mental state of the user (the degree of impression, excitation, or wakefulness, feelings, emotions, etc. on whether the user is immersed or concentrated in observation of displayed image) and gives an instruction to automatically provide an image, the role switching unit 602 switches the image display apparatus 100 to a field-of-view provider mode. When switching the image display apparatus 100 to the field-of-view provider mode, the role switching unit 602 activates operations of respective units 601 and 603 to 605.

The image display apparatus 100 switched to be a field-of-view provider performs processing to transmit or release the image, which is input from the image input unit 601, to a field-of-view receiver. In the case where the external camera 512 captures an image in a user's line-of-sight direction and the image input unit 601 inputs that captured image, the image display apparatus 100 provides a field of view of the user.

For example, when encountering a scene in which fish has just jumped up from the water surface of a pond (see FIG. 11) or a scene in which a rare bird has just flown out of trees (see FIG. 12), a user is impressed or excited and feels like showing such a scene to someone. When the user gives an instruction to provide an image via the input operation unit 502 or the state detection unit 511 detects an impression or excitement of the user, in response to this, the role switching unit 602 switches the image display apparatus 100 to the field-of-view provider mode.

Additionally, when the transmission of images (i.e., sharing of images with field-of-view receiver) is ended or the user has less motivation to be the field-of-view provider (for example, when the state detection unit 511 detects that the user awakes out of the impression or excitement for the displayed image), the role switching unit 602 returns the image display apparatus 100 to be in the field-of-view receiver mode.

In accordance with the switching of the image display apparatus 100 to be a field-of-view provider, which is performed by the role switching unit 602, a field-of-view receiver setting unit 603 sets a field-of-view receiver, that is, sets an image display apparatus to be a destination to which an image is transmitted.

The field-of-view receiver setting unit 603 may search for an image display apparatus, which is to be a field-of-view receiver, around the field-of-view provider. In this case, the field-of-view receiver setting unit 603 transmits (broadcasts) an image release message from the communication unit 505 by transmission power whose receivable range is within a predetermined distance. The field-of-view receiver setting unit 603 then sets an image display apparatus as a field-of-view receiver, the image display apparatus having returned an acknowledgment message within a predetermined period of time. It should be noted that the number of field-of-view receivers to which access is limited may be set within a predetermined value (for example, within three) in consideration of a communication load or the leakage of information and privacy. For example, it may be selected based on the arrival sequence of acknowledgment messages or by a lottery of field-of-view receivers whose acknowledgment messages have been received within a predetermined period of time.

Additionally, the field-of-view receiver setting unit 603 may set a range, which is viewed from the field-of-view provider, for a field-of-view receiver. In this case, the user serving as a field-of-view provider specifies a field-of-view receiver with eye contact. Specifically, the field-of-view receiver setting unit 603 finds a user in the user's line-of-sight direction detected by the state detection unit 511 and sets the user to be a field-of-view receiver. When another user in the line-of-sight direction gives a predetermined sign or a gesture such as giving a look, or exclusively for another user who reaches an agreement through other actions, such a user may be set to be a field-of-view receiver.

Alternatively, irrespective of the current positions of the users, the field-of-view receiver may be registered in advance in the field-of-view receiver setting unit 603. For example, information such as a MAC (Media Access Control) address or an IP (Internet Protocol) address of a field-of-view receiver, with which an image display apparatus of each field-of-view receiver can be uniquely identified, is set in the field-of-view receiver setting unit 603. Additionally, the field-of-view receiver setting unit 603 may transmit an image release message to a field-of-view receiver preliminarily registered, and set only a field-of-view receiver who has returned an acknowledgment message to be a final field-of-view receiver.

A face image of a user who can be a field-of-view receiver may be registered. For example, the field-of-view receiver setting unit 603 captures a face image of a user who can be a field-of-view receiver with use of the external camera 512 and stores the face image as authentication information. The face image may be stored in the field-of-view receiver setting unit 603 or the recording unit 506. When the image display apparatus 100 is switched to the field-of-view provider mode, in the case where a face image of the user appearing in the images of surroundings, which are captured by the external camera 512, is recognized and it is matched with a face image preliminarily registered, the field-of-view receiver setting unit 603 may set the user to be a field-of-view receiver. Alternatively, of users who have returned acknowledgment messages in response to the image release message, only a user whose face is recognized may be set to be a field-of-view receiver.

In any of the case where the field-of-view receiver setting unit 603 dynamically sets a field-of-view receiver and the case where a field-of-view receiver is preliminarily registered, all field-of-view receivers may not be evenly treated but be classified into two or more categories in accordance with the level of privacy or security.

In the case where the field-of-view receiver setting unit 603 dynamically sets a field-of-view receiver from the surroundings of the field-of-view provider, and in the case where the image display apparatus 100 cannot set even one field-of-view receiver within a predetermined period of time from when being switched to the field-of-view provider mode (for example, in the case where an acknowledgment message cannot be received within a predetermined period of time even if an image release message is notified), the field-of-view receiver setting unit 603 gives up providing an image to a field-of-view receiver. In this case, the role switching unit 602 switches the display apparatus 100 to the field-of-view receiver mode and returns to a state of waiting for an image provided from another field-of-view provider.

An additional information creation unit 604 creates additional information as appropriate. The additional information is transmitted together with an image provided to a field-of-view receiver. Examples of the additional information include information of a line-of-sight direction of a field-of-view provider, which is detected by the state detection unit 511, and information of a direction pointed out with the tip of the user's finger. In the line-of-sight direction, there is an object found by the field-of-view provider (i.e., rare or valuable thing). When the object is hard to find in an image received by the field-of-view receiver, the line-of-sight direction of the field-of-view provider becomes important information (a clue to find the object).

The additional information creation unit 604 creates, as additional information, GUI (Graphical User Interface) information such as a highlight and a marker superimposed and displayed on an object in an image in the user's line-of-sight direction, and navigation information formed of texts, sounds, and the like that indicate a position of the object in the image, for example. Alternatively, the additional information creation unit 604 may recognize, as an image, not the additional information such as a highlight and a marker but an object in the user's line-of-sight direction in the line-of-sight direction, and then accentuate only the object by zooming-in for drawing.

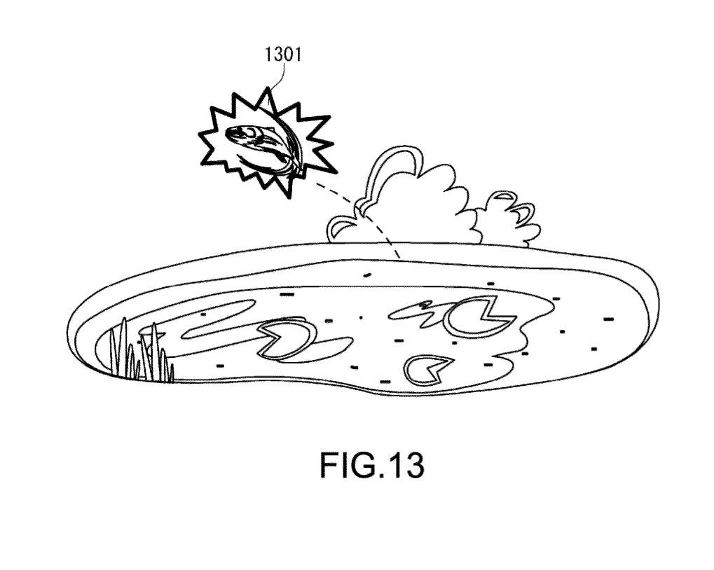

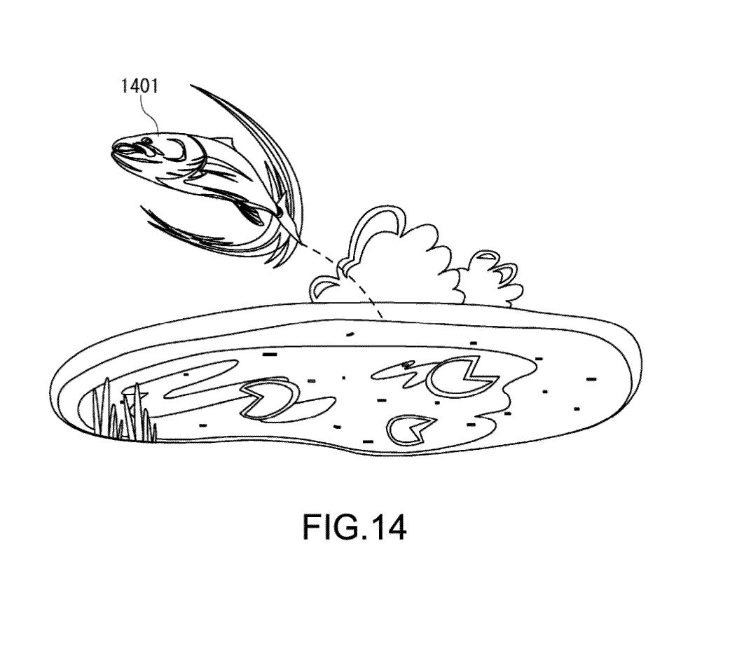

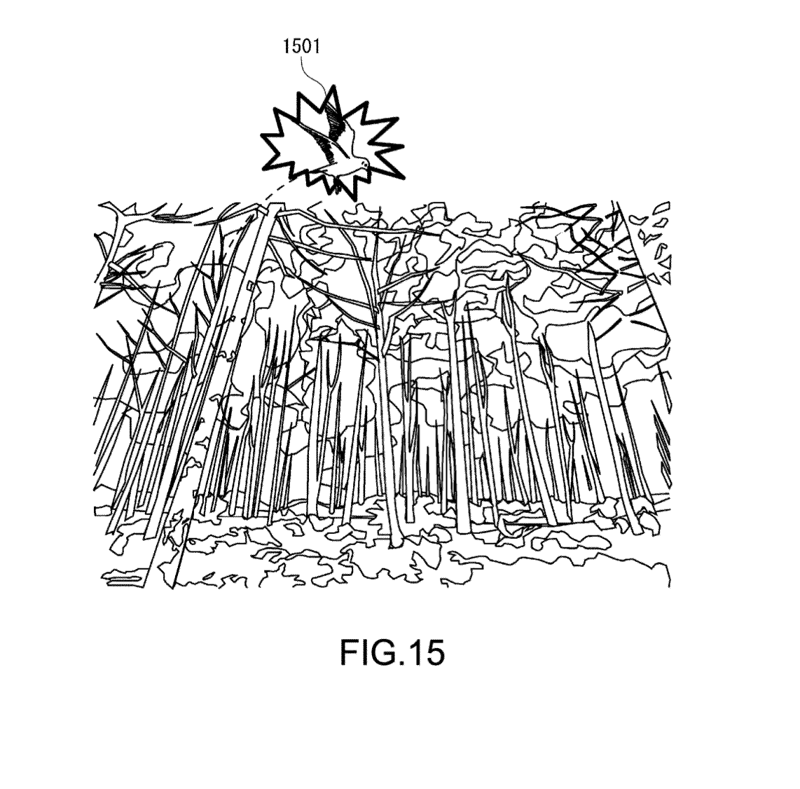

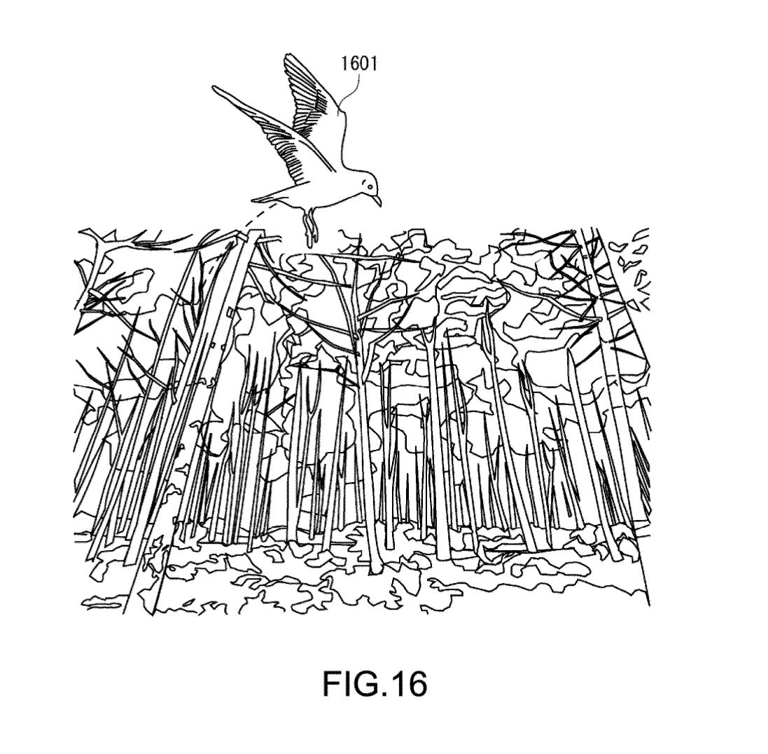

For example, in the case where a captured image of a scene in which fish has just jumped up from the water surface of a pond is provided, when recognizing the fish in the line-of-sight direction of the user (field-of-view provider) from the image captured by the external camera 512, the additional information creation unit 604 creates a highlight or a marker 1301 provided to the fish, as shown in FIG. 13, or creates an image 1401 in which the fish is zoomed in, as shown in FIG. 14. Additionally, in the case where a captured image of a scene in which a bird has just flown out of trees is applied, when recognizing the bird in the line-of-sight direction of the user (field-of-view provider) from the image captured by the external camera 512, the additional information creation unit 604 creates a highlight or a marker 1501 provided to the bird, as shown in FIG. 15, or creates an image 1601 in which the bird is zoomed in, as shown in FIG. 16. A highlight or the marker 1301 or 1501 may be displayed for an object such as fish and a bird based on three-dimensional information of images of surroundings acquired from the external camera 512, for example.

Additionally, the additional information creation unit 604 may use sounds as the additional information as it is, the sounds being input by the field-of-view provider from the sound input and output unit 514.

An image transmission unit 605 transmits the image input to the image input unit 601 toward an image display apparatus of each field-of-view receiver. Each field-of-view receiver is set by the field-of-view receiver setting unit 603. For the transmission processing, the communication unit 505 can be used. An image to be transmitted may be a live image captured by the external camera 512 or a still image captured when a field-of-view provider finds an object. Alternatively, an image to be transmitted may be a moving image or a still image that is reproduced from the recording unit 506.

The image transmission unit 605 then transmits the additional information as well to the field-of-view receiver as appropriate, the additional information being created in the additional information creation unit 604. When additional information is created in the additional information creation unit 604, the image transmission unit 605 may always transmit an image with additional information. Alternatively, only when a user as a field-of-view provider specifies transmission of additional information, the additional information may be transmitted, or the additional information may be transmitted only to a specified field-of-view receiver.

For example, in the case where the field-of-view receiver setting unit 603 classifies the field-of-view receivers into two or more categories in accordance with the level of privacy or security, the image transmission unit 605 may put restriction such that the additional information is transmitted to only field-of-view receivers set at high level. This is because user's line-of-sight information and the like are information related to privacy as well.

In short, the image display apparatus 100 for a field-of-view provider releases and transmits the field of view of a user who finds a valuable thing, and can thus easily share a user's own precious experience with a field-of-view receiver.

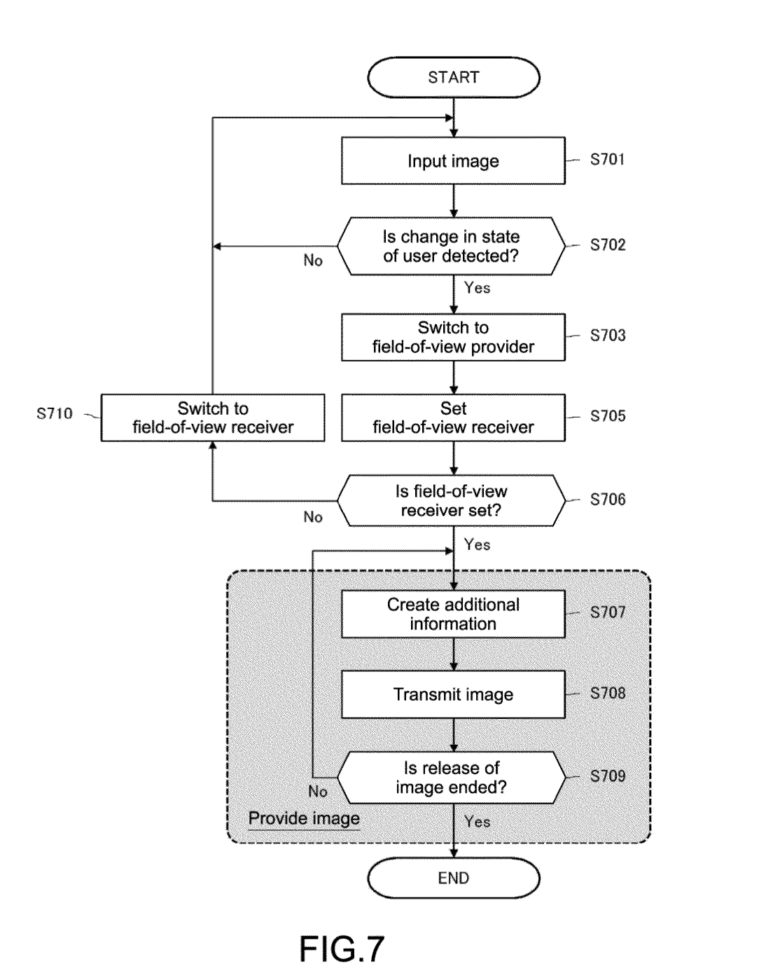

FIG. 7 shows a flowchart of a processing procedure for the image display apparatus 100 to operate for a field-of-view provider.

The image input unit 601 inputs an image to be provided to a field-of-view receiver (Step S701). The image input unit 601 can input a live image in a user's line-of-sight direction, which is captured by the external camera 512, for example. Additionally, the image input unit 601 can input past captured images stored in the recording unit 506. The input image during processing is output to the display unit 509 for display.

Here, a user finds a rare or valuable thing and is then impressed or excited. The state detection unit 511 detects such a change in mental state of the user or responds to a user's instruction on a change in state of the user from the input operation unit 502 (Yes of Step S702), the role switching unit 602 switches the image display apparatus 100 to be a field-of-view provider (Step S703) and starts releasing the image.

The field-of-view receiver setting unit 603 attempts to set a field-of-view receiver over a predetermined period of time (Step S704).

For example, the field-of-view receiver setting unit 603 transmits an image release message by transmission power whose receivable range is within a predetermined distance and waits for a response of an acknowledgment message. Alternatively, the field-of-view receiver setting unit 603 transmits an image release message to a previously registered field-of-view receiver and waits for a response of an acknowledgment message.

After the elapse of the predetermined period of time, when the field-of-view receiver setting unit 603 cannot set even one field-of-view receiver (No of Step S705), the release of the image to a field-of-view receiver is given up. In this case, the role switching unit 602 restores the image display apparatus 100 to the field-of-view receiver mode (Step S710), and the processing returns to Step S701.

On the other hand, when the field-of-view receiver setting unit 603 can set one or more field-of-view receivers (Yes of Step S705), the additional information creation unit 604 attempts to create additional information as appropriate, the additional information being transmitted together with an image provided to the field-of-view receivers (Step S707). The additional information includes, for example, a highlight or a marker that indicates a user's line-of-sight direction, or an enlarged image of an object that is recognized as an image in the line-of-sight direction (see FIGS. 13 to 16).

In the case where the field-of-view receivers are classified into two or more categories in accordance with the level of privacy or security and only field-of-view receivers to which additional information cannot be transmitted at low level are set in Step S704, the additional information creation unit 604 may omit creation of the additional information.

The image transmission unit 605 then transmits a moving image or a still image, which is input by the image input unit 601, toward an image display apparatus of each field-of-view receiver set by the field-of-view receiver setting unit 603 (Step S708).

Additionally, in Step S708, the image transmission unit 605 transmits additional information as well as appropriate to the field-of-view receivers, the additional information being created in the additional information creation unit 604. In the case where the field-of-view receivers are classified into two or more categories in accordance with the level of privacy or security, and for field-of-view receivers set to be at low level in Step S704, the image transmission unit 605 does not transmit the additional information thereto.

In the case where the release of the image is continued (No of Step S709), the creation of the additional information (Step S707) and the transmission of the image (Step S708) are repeatedly executed.

After that, when the user gives an instruction to end the release of the image via the input operation unit 502, or when the state detection unit 511 detects that an impression or excitement of the user weakens, and determines the release of the image to be unnecessary (Yes of Step S709), this processing routine is ended.

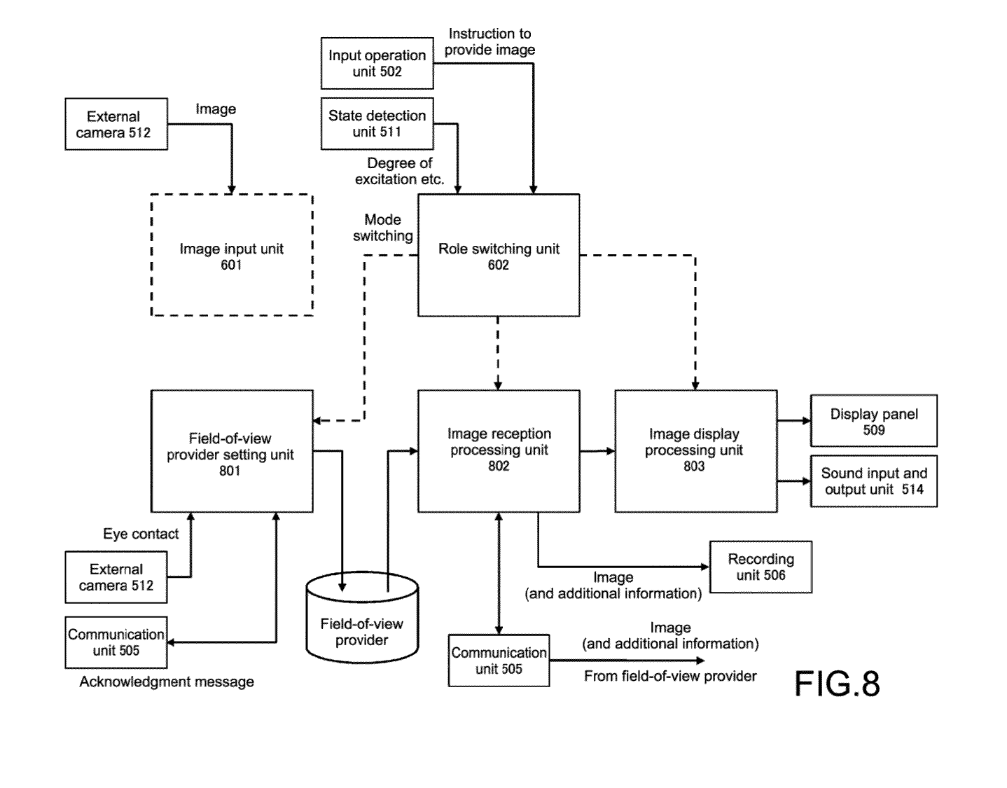

Additionally, FIG. 8 shows a functional configuration for the image display apparatus 100 to operate for a field-of-view receiver.

The image display apparatus 100 basically operates as a field-of-view receiver as long as the role switching unit 602 does not switch the image display apparatus 100 to be a field-of-view provider. When the image display apparatus 100 is set to the field-of-view receiver mode, for example, the communication unit 505 is in a standby state for an image release message. Even in the field-of-view receiver mode, the external camera 512 captures an image in a user's line-of-sight direction, but the image input unit 601 does not take in the image captured by the external camera 512. When switching the image display apparatus 100 to the field-of-view receiver mode, the role switching unit 602 activates operations of respective units 801 to 803.

A field-of-view provider setting unit 801 sets the other party from which the image display apparatus 100 receives an image, that is, an image display apparatus to be a field-of-view provider. When receiving an image release message in the communication unit 505, the field-of-view provider setting unit 801 sets a transmission source of this message to be a field-of-view provider, and returns an acknowledgment message to the field-of-view provider.

For example, when finding a rare or valuable thing, any user who wears the image display apparatus 100 can be a field-of-view provider. When indefinitely receiving images provided from all field-of-view providers, however, the field-of-view receiver suffers negative effects such as an increase in communication load and a difficulty of viewing images that the user originally wants to view. In this regard, the field-of-view provider setting unit 801 limits the field-of-view providers as described above, and limits or refuses provision of images from any other image display apparatuses.

The field-of-view provider setting unit 801 may preliminarily set an image display apparatus from which an image may be provided, and may limit or refuse provision of images from any other image display apparatuses. Additionally, when a field-of-view provider is preliminarily set in the field-of-view provider setting unit 801, the field-of-view provider setting unit 801 returns an acknowledgment message exclusively to a field-of-view provider for which a transmission source of the image release message is preliminarily set. As a matter of course, when such a limitation is not provided and all provided images are intended to be received, a preliminary setting of a field-of-view provider in the field-of-view provider setting unit 801 can be omitted.

Additionally, when a face image of a user to be a field-of-view provider is stored, at the time of reception of an image release message, the field-of-view provider setting unit 801 recognizes a face image of a user appearing in the images of surroundings captured by the external camera 512. Only in the case where the face image is matched with the face image preliminarily registered, an acknowledgment message may be returned.

Additionally, the user to be a field-of-view receiver may specify a field-of-view provider with eye contact, for example. Specifically, the field-of-view provider setting unit 801 preliminarily sets a user to be a field-of-view provider, the user being found in the user's line-of-sight direction detected by the state detection unit 511. When the user in the line-of-sight direction gives a predetermined sign or a gesture such as giving a look, or exclusively when the user reaches an agreement through other actions, the field-of-view provider setting unit 801 may set such a user to be a field-of-view provider. A face image of the user to be a field-of-view provider may be captured by the external camera 512 and then stored.

An image reception processing unit 802 performs reception processing on the image in the communication unit 505, the image being transmitted from the field-of-view provider. Additionally, in the case where additional information is also transmitted together with the image from the field-of-view provider, the additional information is also subjected to the reception processing. It should be noted that when a user to be a field-of-view provider is preliminarily set in the field-of-view provider setting unit 801, the image reception processing unit 802 refuses a reception of an image from a user who is not preliminarily set, or discards the received image. Additionally, when a face image of a user to be a field-of-view provider is stored, at the time of reception of an image, the image reception processing unit 802 recognizes a face image of a user appearing in the images of surroundings captured by the external camera 512, and only in the case where the face image is matched with the face image preliminarily registered, performs the reception processing.

It should be noted that the image reception processing unit 802 may store a received image or additional information in the recording unit 506 as appropriate.

An image display processing unit 803 processes display and output of the image, which is received in the image reception processing unit 802, on and to the display unit 509. Examples of a method of displaying the received image include a method of displaying the received image by superimposition on an image being currently displayed, a method of displaying the received image on any one of the right and left (in the case of a binocular type), and a method of displaying the received image as a sub-screen of an image being currently displayed (the “image being currently displayed” referred to herein includes an image in a line-of-sight direction of a field-of-view receiver and a video image being viewed by a field-of-view receiver). Additionally, displaying of the image being currently displayed and the received image may be exchanged between a main screen and a sub-screen, or may be switched to split displaying, not to displaying in a main-sub relationship.

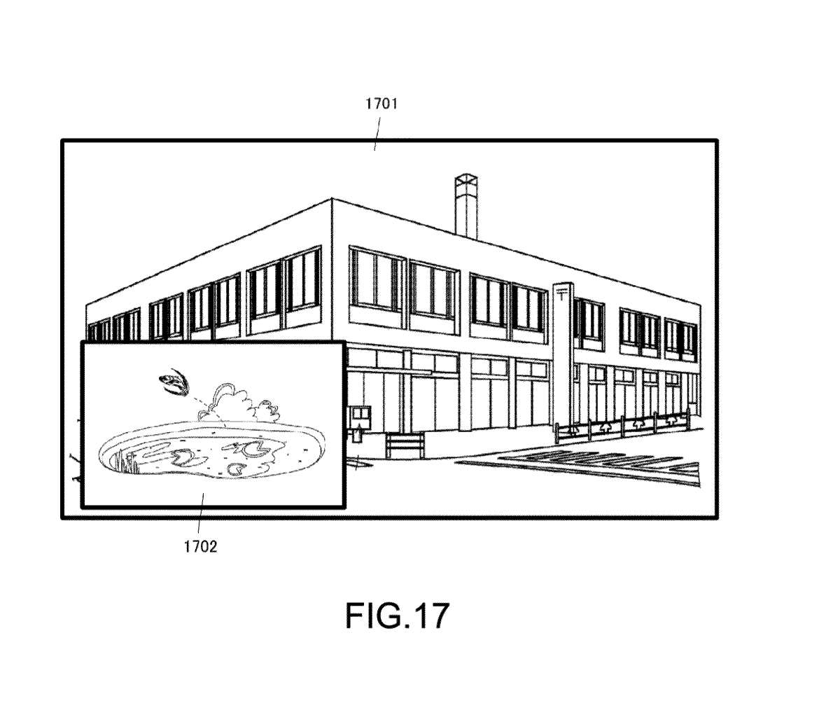

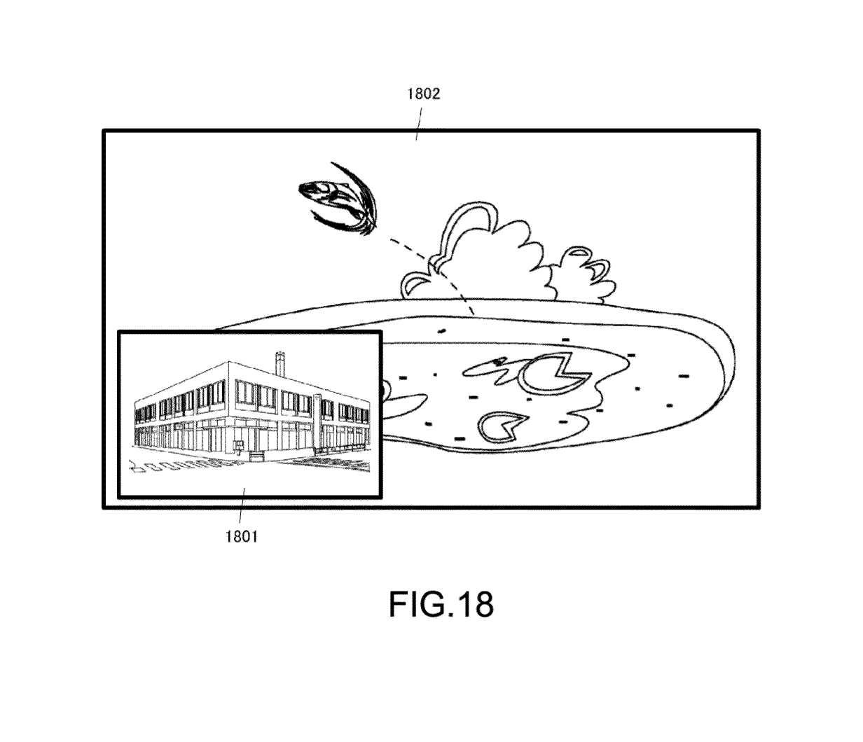

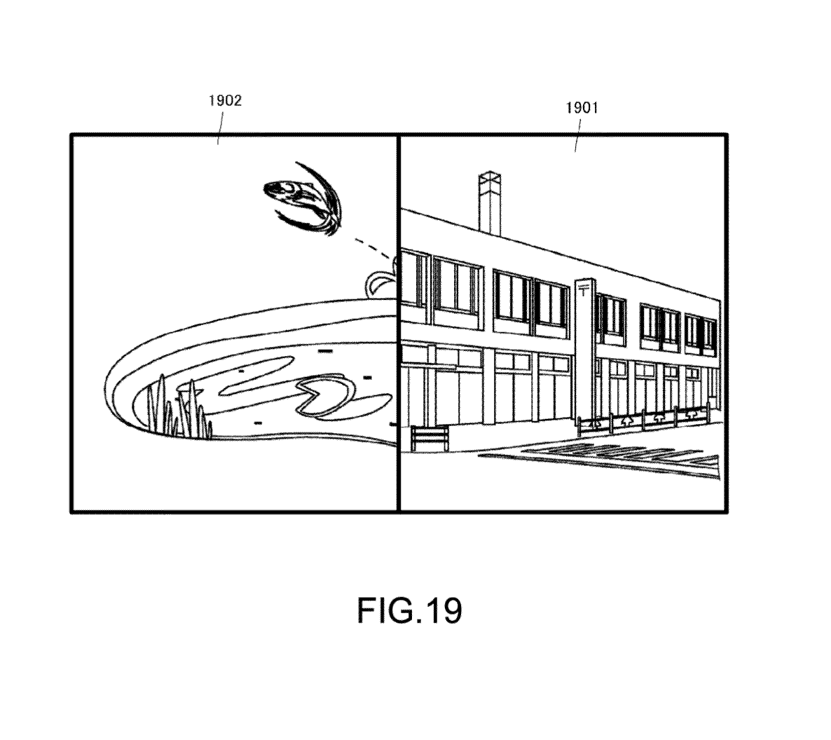

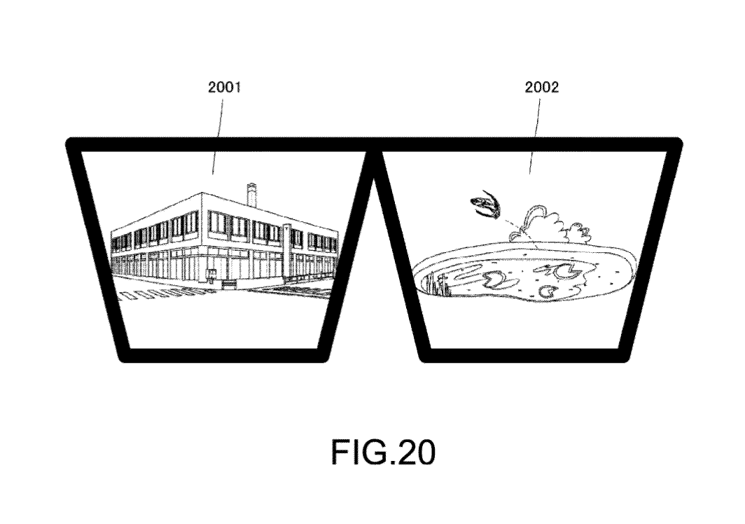

FIG. 17 shows a state where an image 1702 of a field-of-view provider viewing a pond is displayed on a sub-screen of a field-of-view receiver viewing a street corner 1701, the image 1702 being transmitted from the field-of-view provider. Additionally, FIG. 18 shows a state where an image 1801 in a line-of-sight direction of the field-of-view receiver as a main screen, and an image 1802 received from the field-of-view provider as a sub-screen are replaced with each other. Further, FIG. 19 shows a state where an image 1901 in the line-of-sight direction of the field-of-view receiver and an image 1902 received from the field-of-view provider are displayed by splitting the screen. Additionally, FIG. 20 shows a state where an image 2001 in the line-of-sight direction of the field-of-view receiver is see-through displayed on the left side of a binocular image display apparatus 100 and an image 2002 transmitted from the field-of-view provider is displayed on the right side of the binocular image display apparatus 100.

The user may instruct the image display processing unit 803 to switch the screen via the input operation unit 502 or by movements of the eyes or eyelids such as blinking operations. The “image being currently displayed” referred to herein includes a see-through image.

In the case where the additional information is also received together with the image from the field-of-view provider, the image display processing unit 803 performs special processing as well on the received image, based on the additional information.

In the case where the additional information is the line-of-sight direction of the field-of-view provider, the image display processing unit 803 may display a highlight or a marker in the received image. The highlight or the marker indicates the line-of-sight direction. This facilitates the field-of-view receiver to focus on the highlight or the marker and find a rare or valuable thing found by the field-of-view provider. For example, in the case where a captured image of a scene in which fish has just jumped up from the water surface of a pond is provided, when recognizing the fish in the line-of-sight direction of the user (field-of-view provider) from the received image, the image display processing unit 803 creates a highlight or a marker provided to the fish, as shown in FIG. 13. Additionally, in the case where a captured image of a scene in which a bird has just flown out of trees is provided, when recognizing the bird in the line-of-sight direction of the user (field-of-view provider) from the received image, the image display processing unit 803 creates a highlight or a marker provided to the bird, as shown in FIG. 15.

Alternatively, the image display processing unit 803 may recognize, as an image, not the additional information such as a marker but an object in the user's line-of-sight direction, and then accentuate only the object by enlargement for drawing. The object displayed in the enlarged manner stands out and is thus easily found by the field-of-view receiver. For example, in the case where a captured image of a scene in which fish has just jumped up from the water surface of a pond is provided, when recognizing the fish in the line-of-sight direction of the user (field-of-view provider) from the received image, the image display processing unit 803 creates an image in which the fish is zoomed in, as shown in FIG. 14. Additionally, in the case where a captured image of a scene in which a bird has just flown out of trees is provided, when recognizing the bird in the line-of-sight direction of the user (field-of-view provider) from the received image, the image display processing unit 803 creates an image in which the bird is zoomed in, as shown in FIG. 16.

Additionally, in the case where the additional information is the GUI information such as a highlight and a marker superimposed on the object in the image, the image display processing unit 803 superimposes and displays the GUI information on the image being currently displayed or on a sub-screen on which the image is displayed (the sub-screen may be a main screen or split screen).

Additionally, in the case where the additional information is the navigation information formed of texts, sounds, and the like that indicate a position of the object in the field-of-view image, the image display processing unit 803 displays the navigation information as subtitles on the display unit 509 or outputs the navigation information as sounds from the sound input and output unit 514.

When viewing the received image, the field-of-view receiver starts searching for the object found by the field-of-view provider while saying “Which?”, “Where?”, or the like. The field-of-view receiver then immediately finds the object and can sympathize while shouting with pleasure, “Found it. Great!” For a field-of-view receiver who cannot find the object immediately, further supports can be provided by using a highlight or a marker of the line of sight of the field-of-view provider, zooming, displaying of the navigation information, and output of sounds. This facilitates the field-of-view receiver who has a difficulty in finding the object found by the field-of-view provider to find out the object, and a precious experience of the field-of-view provider can be shared.

However, in the case where the image display apparatus 100 of the field-of-view receiver intends to reduce a load of arithmetic processing for the additional information, the image reception processing unit 802 may discard the additional information transmitted together with the image. Additionally, the image display processing unit 803 may not perform special processing such as displaying of the additional information, a highlight or a marker that indicates a line-of-sight direction, and zooming-in. Alternatively, the field-of-view provider setting unit 801 may refuse transmission of the additional information at the time of transmission of an acknowledgment message, for example.

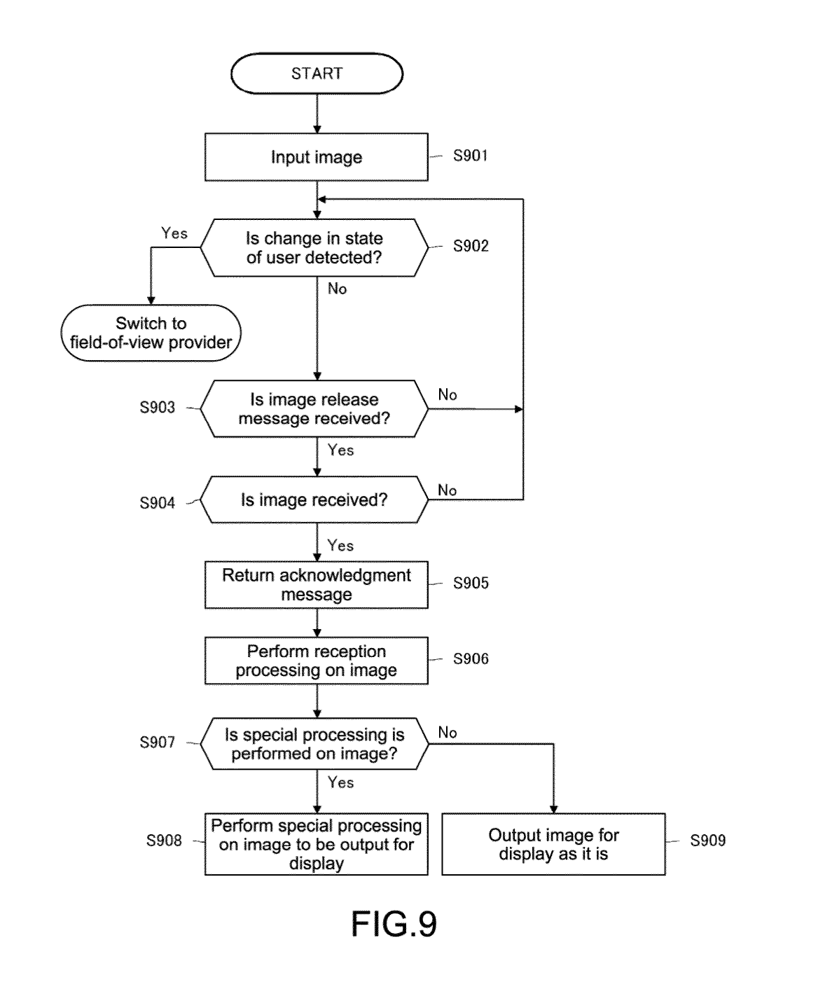

FIG. 9 shows a flowchart of a processing procedure for the image display apparatus 100 to operate for the field-of-view receiver.

The image input unit 601 inputs an image captured by the external camera 512 (Step S901). The external camera 512 captures an image of a landscape in a user's line-of-sight direction, for example.

Here, when the state detection unit 511 detects that the user is impressed or excited by the landscape in the line-of-sight direction (Yes of Step S902), the image display apparatus 100 is switched to be a field-of-view provider and the processing procedure (described above) shown in FIG. 7 is executed. On the other hand, if the mental state of the user is not changed or the user does not give an instruction to provide an image (No of Step S902), the image display apparatus 100 still remains to be in the field-of-view receiver mode, and the image input unit 601 does not take in an image captured by the external camera 512.

When receiving an image release message from a field-of-view provider (Yes of Step S903), the field-of-view provider setting unit 801 checks whether an image provided from a transmission source of the message is received or not (Step S904).

The field-of-view provider setting unit 801 checks whether a transmission source of the image release message is preliminarily registered as a field-of-view provider of the field-of-view provider setting unit 801 or not, for example. Alternatively, the field-of-view provider setting unit 801 checks whether the user admits the transmission source of the message as a field-of-view provider by eye contact, a gesture, or other actions.

Here, in the case where the image provided from the transmission source of the image release message is received (Yes of Step S904), an acknowledgment message is returned (Step S905). It should be noted that in the acknowledgment message, whether additional information of the image is required or not may be described. On the other hand, in the case where the image is not received (No of Step S904), nothing is performed.

When receiving an acknowledgment message, the transmission source of the image release message transmits a field-of-view image of the field-of-view provider together with additional information as appropriate. In the image display apparatus 100 on the field-of-view receiver side, the image reception processing unit 802 performs reception processing on the image transmitted from the field-of-view provider in the communication unit 505 (Step S906). Additionally, in the case where the additional information is also transmitted together with the image, the reception processing is also performed on the additional information.

The image display processing unit 803 then processes display and output of the image on and to the display unit 509, the image being received in the image reception processing unit 802. At that time, it is checked whether or not to perform special processing for images, such as displaying of the additional information, a highlight or a marker that indicates a line-of-sight direction, and zooming-in (Step S907). Whether the special processing is performed or not may be selected by the user or automatically selected in consideration of arithmetic addition of the image display apparatus 100, for example.

When it is determined to perform the special processing (Yes of Step S907), any one of specified special processing, such as displaying of the additional information, a highlight or a marker that indicates a line-of-sight direction, and zooming-in, is performed, and the image is then output for display to the display unit 509 (Step S908).

Alternatively, when it is not determined to perform the special processing (No of Step S907), the image received in Step S905 is output for display to the display unit 509 as it is (Step S909).

It should be noted that the method of displaying the image in Steps S908 and S909 includes various methods such as a method of displaying the image on any one of the right and left of the binocular image display apparatus 100, sub-screen displaying, and split displaying.

As described above, the processing procedure shown in FIG. 7 is executed by the image display apparatus 100 on the field-of-view provider side, and the processing procedure shown in FIG. 9 is executed by the image display apparatus 100 on the field-of-view receiver side. This allows users to easily share an experience of finding a rare or valuable thing.

It should be noted that the functions of the field-of-view receiver setting unit 603 and the field-of-view provider setting unit 801 and pairing of a field-of-view receiver and a field-of-view provider may be achieved by an apparatus outside the image display apparatus 100, such as a server.

Patent Document 1: Japanese Patent Application Laid-open No. 2008-147865, paragraphs 0024 to 0026

Patent Document 2: Japanese Patent Application Laid-open No. 2008-154192

Patent Document 3: Japanese Patent Application Laid-open No. 2009-21914

Patent Document 4: Japanese Patent Application Laid-open No. 2011-2753

Patent Document 5: Japanese Patent Application Laid-open No. 2008-304268

### INDUSTRIAL APPLICABILITY

Hereinabove, the technology disclosed in this specification has been described in detail with reference to the specific embodiment. However, it is obvious that the embodiment can be modified or substituted by a person having ordinary skill in the art without departing from the gist of the technology disclosed herein.

The image display apparatuses each used by being mounted onto the head or face of a user can be classified into a light-shielding type and a transmissive type. The technology disclosed herein can be applied to any one of those types. Additionally, the image display apparatuses of those types can be classified into a binocular type including display units for the right and left eyes and a monocular type including a display unit for any one of the right and left eyes. The technology disclosed herein can be applied to any one of the types. As a matter of course, even when the technology disclosed herein is applied to an image display apparatus of a type that is not mounted onto the head or face of the user, images can be exchanged between users similarly.

In short, the technology disclosed herein has been described as an example, and the content described in this specification should not be construed in a limited way. In order to determine the gist of the technology disclosed herein, the scope of claims should be considered.

It should be noted that the technology disclosed herein can have the following configurations.

(1) An image display apparatus of a head- or face-mounted type, the image display apparatus including:

an image display unit that displays an image;

an image input unit that inputs an image;

a reception-terminal setting unit that sets a reception terminal, the reception terminal being a transmission destination of the image input to the image input unit; and

an image transmission unit that transmits the image to the reception terminal, the image being input to the image input unit.

(2) The image display apparatus according to (1), further including a state detection unit that detects a state of a user who uses the image display apparatus, in which

in response to a detection of a predetermined state of the user by the state detection unit, the image transmission unit starts or stops transmitting the image to the reception terminal, the image being input to the image input unit.

(3) The image display apparatus according to (1), further including an input operation unit, in which

in response to an instruction of the user via the input operation unit, the field-of-view image transmission unit starts or stops transmitting the field-of-view image to the field-of-view receiver.

(4) The image display apparatus according to (1), in which

the reception-terminal setting unit transmits an image release message and sets a reception terminal that returns an acknowledgment message.

(5) The image display apparatus according to (1), in which

the reception-terminal setting unit sets a reception terminal specified by the user.

(6) The image display apparatus according to (1), in which

the reception-terminal setting unit preliminarily registers a reception terminal.

(7) The image display apparatus according to (1), in which

when the reception-terminal setting unit cannot set any one reception terminal, the image transmission unit does not transmit the image input to the image input unit.

(8) The image display apparatus according to (1), further including an additional information creation unit that creates additional information, the additional information being transmitted together with the image input to the image input unit, in which

the image transmission unit transmits the additional information to the reception terminal, together with the image input to the image input unit.

(9) The image display apparatus according to (8), in which

the reception-terminal setting unit classifies the reception terminals into two or more categories, and

the image transmission unit transmits the additional information to only the reception terminal in a predetermined category.

(10) The image display apparatus according to (8), in which

the image input unit inputs an image in a line-of-sight direction of a user who uses the image display apparatus, and

the additional information creation unit creates additional information on a line of sight of the user or additional information indicating an object in a line-of-sight direction.

(11) The image display apparatus according to (1), further including an imaging unit, in which

the image input unit inputs an image captured by the imaging unit.

(12) The image display apparatus according to (1), further including:

an imaging unit; and

a recording unit that records a captured image of the imaging unit, in which

the image input unit inputs the captured image from the recording unit.

(13) An image display apparatus of a head- or face-mounted type, the image display apparatus including:

an image reception processing unit that performs reception processing on an image transmitted from a transmission terminal; and

an image display unit that displays the image subjected to the reception processing.

(14) The image display apparatus according to (13), further including a transmission-terminal setting unit that sets the transmission terminal, in which

the image reception processing unit receives only an image from the transmission terminal, the transmission terminal being set by the transmission-terminal setting unit.

(15) The image display apparatus according to (14), in which

the transmission-terminal setting unit returns an acknowledgment message in response to an image release message from the transmission terminal.

(16) The image display apparatus according to (14), in which

the transmission-terminal setting unit sets a transmission terminal specified by the user.

(17) The image display apparatus according to (14), in which

the transmission-terminal setting unit preliminarily registers a transmission terminal.

(18) The image display apparatus according to (13), in which

the image reception processing unit selectively receives additional information that is transmitted together with the image.

(19) The image display apparatus according to (13), in which

the image display unit includes display screens for right and left eyes of a user who uses the image display unit, and displays the image on any one of right and left display screens, the image being subjected to the reception processing.

(20) The image display apparatus according to (13), in which

the image display unit displays the image on the display screen as a sub-screen or a split screen, the image being subjected to the reception processing.

(21) The image display apparatus according to (13), in which

the image reception processing unit performs display processing of additional information transmitted together with the image.

(22) The image display apparatus according to (13), in which

the transmission terminal transmits an image in a line-of-sight direction of a user of the transmission terminal, together with additional information containing information on a line of sight of the user, and

the image reception processing unit performs special processing on the image received from the transmission terminal, based on the information on the line of sight of the user, the information being received as the additional information.

(23) The image display apparatus according to (13), further including a recording unit that records additional information or an image received from the transmission terminal.
(24) An image display method, including:

inputting an image;

setting a reception terminal, the reception terminal being a transmission destination of the image input in the step of inputting an image; and

transmitting the image to the reception terminal, the image being input in the step of inputting an image.

(25) An image display method, including:

performing reception processing on an image transmitted from a transmission terminal; and

outputting the image for display, the image being subjected to the reception processing.

(26) An image display system, including:

a transmission-side image display apparatus of a head- or face-mounted type, the transmission-side image display apparatus transmitting an input image; and

a reception-side image display apparatus of a head- or face-mounted type, the reception-side image display apparatus displaying the image transmitted from the transmission-side image display apparatus.

(27) A computer program, which is described in a computer-readable format to cause a computer to function as:

an image display unit that displays an image;

an image input unit that inputs an image;

a reception-terminal setting unit that sets a reception terminal, the reception terminal being a transmission destination of the image input to the image input unit; and

an image transmission unit that transmits the image to the reception terminal, the image being input to the image input unit,

the computer program controlling an image display apparatus that is used by being mounted onto a head or face of a user.

(28) A computer program, which is described in a computer-readable format to cause a computer to function as:

an image reception processing unit that performs reception processing on an image transmitted from a transmission terminal; and

an image display unit that displays the image subjected to the reception processing,

the computer program controlling an image display apparatus that is used by being mounted onto a head or face of a user.

### DESCRIPTION OF SYMBOLS

100 image display apparatus (transmissive type)
101L, 101R virtual image optical unit
102 support body
103L, 103R microphone
104L, 104R display panel
300 image display apparatus (immersion type)
301L, 301R virtual image optical unit
303L, 303R microphone
304L, 304R display panel
305 pupillary distance adjustment mechanism
501 control unit
501A ROM
501B RAM
502 input operation unit
503 remote-controller reception unit
504 posture/position detection unit
505 communication unit
506 recording unit
507 image processing unit
508 display drive unit
509 display unit
510 virtual image optical unit
511 state detection unit
512 external camera
513 sound processing unit
514 sound input and output unit
601 image input unit
602 role switching unit
603 field-of-view receiver setting unit
604 additional information creation unit
605 image transmission unit
801 field-of-view provider setting unit
802 image reception unit
803 image display processing unit

1. An image display apparatus of a head- or face-mounted type, the image display apparatus comprising:
an image display unit that displays an image;
an image input unit that inputs an image;
a reception-terminal setting unit that sets a reception terminal, the reception terminal being a transmission destination of the image input to the image input unit; and
an image transmission unit that transmits the image to the reception terminal, the image being input to the image input unit.

2. The image display apparatus according to claim 1, further comprising a state detection unit that detects a state of a user who uses the image display apparatus, wherein
in response to a detection of a predetermined state of the user by the state detection unit, the image transmission unit starts or stops transmitting the image to the reception terminal, the image being input to the image input unit.

3. The image display apparatus according to claim 1, wherein
the reception-terminal setting unit transmits an image release message and sets a reception terminal that returns an acknowledgment message.

4. The image display apparatus according to claim 1, wherein
when the reception-terminal setting unit cannot set any one reception terminal, the image transmission unit does not transmit the image input to the image input unit.

5. The image display apparatus according to claim 1, further comprising an additional information creation unit that creates additional information, the additional information being transmitted together with the image input to the image input unit, wherein
the image transmission unit transmits the additional information to the reception terminal, together with the image input to the image input unit.

6. The image display apparatus according to claim 5, wherein
the reception-terminal setting unit classifies the reception terminals into two or more categories, and
the image transmission unit transmits the additional information to only the reception terminal in a predetermined category.

7. The image display apparatus according to claim 5, wherein
the image input unit inputs an image in a line-of-sight direction of a user who uses the image display apparatus, and
the additional information creation unit creates additional information on a line of sight of the user or additional information indicating an object in a line-of-sight direction.

8. The image display apparatus according to claim 1, further comprising an imaging unit, wherein
the image input unit inputs an image captured by the imaging unit.

9. The image display apparatus according to claim 1, further comprising:
an imaging unit; and
a recording unit that records a captured image of the imaging unit, wherein
the image input unit inputs the captured image from the recording unit.

10. An image display apparatus of a head- or face-mounted type, the image display apparatus comprising:
an image reception processing unit that performs reception processing on an image transmitted from a transmission terminal; and
an image display unit that displays the image subjected to the reception processing.

11. The image display apparatus according to claim 10, further comprising a transmission-terminal setting unit that sets the transmission terminal, wherein
the image reception processing unit receives only an image from the transmission terminal, the transmission terminal being set by the transmission-terminal setting unit.

12. The image display apparatus according to claim 11, wherein
the transmission-terminal setting unit returns an acknowledgment message in response to an image release message from the transmission terminal.

13. The image display apparatus according to claim 10, wherein
the image reception processing unit selectively receives additional information that is transmitted together with the image.

14. The image display apparatus according to claim 10, wherein
the image display unit includes display screens for right and left eyes of a user who uses the image display unit, and displays the image on any one of right and left display screens, the image being subjected to the reception processing.

15. The image display apparatus according to claim 10, wherein
the image display unit displays the image on the display screen as a sub-screen or a split screen, the image being subjected to the reception processing.

16. The image display apparatus according to claim 10, wherein
the image reception processing unit performs display processing of additional information transmitted together with the image.

17. The image display apparatus according to claim 10, wherein
the transmission terminal transmits an image in a line-of-sight direction of a user of the transmission terminal, together with additional information containing information on a line of sight of the user, and
the image reception processing unit performs special processing on the image received from the transmission terminal, based on the information on the line of sight of the user, the information being received as the additional information.

18. An image display method, comprising:
inputting an image;
setting a reception terminal, the reception terminal being a transmission destination of the image input in the step of inputting an image; and
transmitting the image to the reception terminal, the image being input in the step of inputting an image.

19. An image display method, comprising:
performing reception processing on an image transmitted from a transmission terminal; and
outputting the image for display, the image being subjected to the reception processing.

20. An image display system, comprising:
a transmission-side image display apparatus of a head- or face-mounted type, the transmission-side image display apparatus transmitting an input image; and
a reception-side image display apparatus of a head- or face-mounted type, the reception-side image display apparatus displaying the image transmitted from the transmission-side image display apparatus.
